(19) United States
(12) Patent Application Publication
(10) Pub. No.: US 2025/0218760 A1
(43) Pub. Date: Jul. 3, 2025

(54) MULTI-REFLECTION TIME-OF-FLIGHT MASS ANALYSER WITH INDEPENDENT TRAPPING REGION

(71) Applicant: Thermo Fisher Scientific (Bremen) GmbH, Bremen (DE)

(72) Inventors: Hamish Stewart, Bremen (DE); Dmitry Grinfeld, Bremen (DE)

(73) Assignee: Thermo Fisher Scientific (Bremen) GmbH, Bremen (DE)

(21) Appl. No.: 18/952,657

(22) Filed: Nov. 19, 2024

(30) Foreign Application Priority Data
Jan. 2, 2024 (GB) 2400009.3

(51) Int. Cl. H01J 49/40

(52) U.S. Cl. CPC H01J 49/406

(57) ABSTRACT

A multi-reflection time-of-flight (MR-ToF) mass analyser comprises two opposing ion mirrors spaced apart in a first direction, each mirror elongated generally along a drift direction between a first end and a second end, the drift direction being orthogonal to the first direction. An ion injector injects ions into a space between the ion mirrors, and the ions are detected after a plurality of reflections between the ion mirrors. A first deflector and/or a lens is between the ion mirrors, proximate the first end of the ion mirrors, a second deflector and/or lens is arranged between the ion mirrors proximate the second end of the ion mirrors or between the first and second ends of the ion mirrors. One or more trapping deflector(s) and/or lens(es) are between the ion mirrors, proximate the second end of the ion mirrors or between the first and second ends of the ion mirrors.

### CROSS REFERENCE TO RELATED APPLICATION

This application claims priority from application GB2400009.3, filed Jan. 2, 2024. The entire disclosure of application GB2400009.3 is incorporated herein by reference.

### FIELD

The present invention relates to the field of time-of-flight mass spectrometry (ToF-MS) and time-of-flight (ToF) mass analysers, and in particular to multi-reflection time-of-flight (MR-ToF) mass analysers.

### BACKGROUND

A multi-reflection time-of-flight (MR-ToF) mass analyser typically includes two elongated ion mirrors which are each arranged along a drift direction Y, where the ion mirrors are spaced apart in an orthogonal X-direction. As ions pass along the analyser in the drift direction Y, they make multiple reflections in the X-direction between the mirrors. The ions are eventually detected by a detector, and their mass to charge ratio (m/z) is determined from their drift time through the analyser.

It can be desirable to increase the resolution of the analyser, both to increase the separation of analyte ions and to improve their accurate mass assignment. Generally, an analyser's resolution is limited by the length of the ion flight path through the analyser, and the arrival time spread of ions at the detector.

The article A. Verenchikov, et al., Journal of Applied Solution Chemistry and Modelling, 2017, 6, 1-22, describes a “zoom mode” for an MR-ToF mass analyser which uses a set of periodic lenses to focus the ion beam, whereby ions can be made to make multiple cycles within the analyser in the drift direction Y. Increasing the number of cycles N increases the length of the ion flight path that ions take within the analyser, thereby increasing the resolution of the analyser.

It is believed that there remains scope for improvements to apparatus and methods for time-of-flight (ToF) mass analysis.

### SUMMARY

A first aspect provides a method of operating a multi-reflection time-of-flight (MR-ToF) mass analyser that comprises:
two ion mirrors spaced apart and opposing each other in a first direction X, each mirror elongated generally along a drift direction Y between a first end and a second end, the drift direction Y being orthogonal to the first direction X;
an ion injector for injecting ions into a space between the ion mirrors;
a detector for detecting ions after they have completed a plurality of reflections between the ion mirrors; and
one or more trapping deflector(s) and/or lens(es) arranged between the ion mirrors;
the method comprising:
injecting a first packet of ions from the ion injector into the space between the ion mirrors, such that the ions follow an ion path having one or more oscillation(s) between the ion mirrors in the direction X whilst drifting in the drift direction Y from the ion injector to the one or more trapping deflector(s) and/or lens(es);
using the one or more trapping deflector(s) and/or lens(es) to cause at least some ions from the first packet of ions to become trapped, during a first time period, in the space between the ion mirrors while completing plural reflections between the ion mirrors; and
at the end of the first time period, causing at least some of the ions trapped by the one or more trapping deflector(s) and/or lens(es) to travel from the one or more trapping deflector(s) and/or lens(es) to the detector for detection;
wherein the method further comprises:
during the first time period: injecting one or more second packet(s) of ions from the ion injector into the space between the ion mirrors, such that the ions follow an ion path having one or more oscillation(s) between the ion mirrors in the direction X whilst drifting in the drift direction Y from the ion injector to the detector.

Embodiments provide a method of operating a multi-reflection time-of-flight MR-ToF) mass analyser. The analyser may be operated in a mode of operation in which a first packet of ions is trapped in an independent trapping region of the analyser using the one or more trapping deflector(s) and/or lens(es). This “trapping” mode of operation beneficially has the effect of increasing the length of the ion path taken by the first ions within the analyser (between the injector and the detector), thereby increasing the resolution of the analysis. Furthermore, the independent trapping region does not take up the entire body of the analyser. This frees up the remainder of the body of the analyser which can be used to perform one or more separate, faster (e.g. single pass) analysis/analyses while the trapping mode separation is still ongoing. Thus, at the same time as the first ions are trapped, one or more second packet(s) of ions may be analysed by the analyser.

It will be appreciated therefore that embodiments provide an improved multi-reflection time-of-flight (MR-ToF) analyser.

The MR-ToF analyser may be of the type that includes a set of periodic lenses configured to keep the ion beam focused along its flight path. Alternatively, the MR-ToF analyser may be of a type in which the ion beam is allowed to spread out relatively broadly (in the drift direction Y) for most of its flight path, which has the benefit of significantly reduced space charge effects within the analyser.

The analyser comprises two elongated ion mirrors that are spaced apart and face one another in a first direction X, where each mirror is elongated along a drift direction Y between a first end and a second end of the ion mirrors, and where the drift direction Y is orthogonal to the first direction X. The two ion mirrors may be parallel to each other.

The mass analyser also comprises an ion injector, a detector, and one or more trapping deflector(s) and/or lens(es) arranged between the ion mirrors. In some embodiments, the ion injector is located in proximity with the first end of the ion mirrors, and the detector is located in proximity with the first end of the ion mirrors. In these embodiments, each of the one or more trapping deflector(s) and/or lens(es) may be located either in proximity with the second end of the ion mirrors or between the first and second ends of the ion mirrors.

In particular embodiments, the analyser is of the type described in UK U.S. Pat. No. 2,580,089, the content of which is incorporated herein by reference. Thus, the analyser may comprise a first deflector (or equivalently, a first lens) located in proximity with the first end of the ion mirrors, and a second deflector (and/or lens) located either in proximity with the second end of the ion mirrors or between the first and second ends of the ion mirrors.

The first deflector may be located approximately equidistant (in the X direction) between the first and second ion mirrors. The first deflector may be arranged along the ion path after the first ion mirror reflection (in the first ion mirror) that the ion beam experiences after being injected from the injector, but before its second ion mirror reflection (in the second ion mirror). Correspondingly, the first deflector may be arranged along the ion path before the final ion mirror reflection (in the second ion mirror) that the ion beam experiences before arriving at the detector, but after its penultimate ion mirror reflection (in the first ion mirror).

The second deflector may be configured to cause the ions to reverse their drift direction velocity, e.g. in proximity with the second end of the ion mirrors, and drift back along the drift direction towards the deflector. To do this, a suitable voltage may be applied to the second deflector, e.g. in the manner described in UK U.S. Pat. No. 2,580,089.

One or more or each of the deflectors described herein (e.g. including the first deflector, the second deflector and each of the one or more trapping deflector(s)) may comprise one or more trapezoid shaped or prism-like electrodes arranged adjacent to the ion beam. This deflector design has a suitably wide acceptance, such that an ion beam that is spread out relatively broadly in the drift direction can be properly received and deflected by the deflector. One or more or each deflector may comprise a first trapezoid shaped or prism-like electrode arranged above the ion beam and a second trapezoid shaped or prism-like electrode arranged below the ion beam. The electrode(s) may be angled with respect to the ion beam, such that when suitable (DC) voltage(s) is (are) applied to the electrode(s), the resulting electric field induces a deflection in the ion beam. Suitable deflection voltages are of the order of ± a few volts, ± tens of volts, or ± hundreds of volts.

Each deflector should be (and in embodiments is) configured such that it can cause the ion beam to be deflected by a desired (selected) angle. The angle by which the ion beam is deflected by the deflector may be adjustable, e.g. by adjusting the magnitude of a (DC) voltage(s) applied to the deflector. The deflector may be configured such that it can deflect the ion beam by any desired angle.

The or each deflector may comprise a drift focusing lens configured to focus the ions in the drift direction Y.

The analyser may be operated in a “normal” mode of operation, whereby ions are injected from the ion injector into the space between the ion mirrors of the analyser. The ions may be reflected in one of the ion mirrors and may then travel to the first deflector and/or lens. The ions may then adopt a zigzag ion path having plural reflections between the ion mirrors in the direction X whilst: (a) drifting along the drift direction Y from the first deflector and/or lens towards the second deflector and/or lens, (b) reversing drift direction at the second deflector and/or lens, and (c) drifting back along the drift direction Y to the first deflector and/or lens. The ions may then be caused to travel from the first deflector and/or lens to the detector for detection.

The analyser may also be operated in a “zoom” mode of operation, whereby ions are caused to complete plural cycles within the analyser, where in each cycle the ions drift in the drift direction Y from the first deflector and/or lens towards the second deflector and/or lens, and back to the first deflector and/or lens. In each cycle, the ions also complete plural reflections between the ion mirrors in the X direction, and so in each cycle, the ions adopt a zigzag ion path through the space between the ion mirrors.

In the zoom mode of operation, the initial cycle may be initiated by injecting the ions into the space between the ion mirrors. The ions may be reflected in one of the ion mirrors and may then travel to the first deflector and/or lens. The ions then adopt a zigzag ion path having plural reflections between the ion mirrors in the direction X whilst: (a) drifting along the drift direction Y from the first deflector and/or lens towards the second deflector and/or lens, (b) reversing drift direction velocity at the second deflector and/or lens, and (c) drifting back along the drift direction Y to the first deflector and/or lens. After the ions have completed this initial cycle, each further cycle may be initiated by using the first deflector and/or lens to reverse the drift direction velocity of the ions (in proximity with the first end of the ion mirrors). To do this, an appropriate voltage may be applied to the first deflector and/or lens that causes ions to leave the first deflector and/or lens with a drift direction velocity opposite to the drift direction velocity with which the ions originally entered the first deflector and/or lens.

After the ions have completed the desired (plural) number of cycles within the analyser, the ions are allowed to travel from the first deflector and/or lens to the detector for detection. To do this, the voltage may be removed from the first deflector and/or lens (or else an appropriate voltage may be applied to the first deflector and/or lens) such that the ions are caused to exit the first deflector and/or lens in a direction towards the detector. The ions may be reflected in (the other) one of the ion mirrors before travelling to (and being detected by) the detector.

This zoom mode of operation beneficially has the effect of increasing the length of the ion path taken by ions within the analyser (between the injector and the detector), thereby increasing the resolution of the analyser. However, this comes at the cost of increased ion residence time within the analyser, during which time no new packets of ions can be analysed by the analyser.

Embodiments provide a method of operating the MR-ToF analyser in a “zoom” mode where the ions trapped in the zoom mode do not take up the entire body of the analyser but are instead confined to one region of the analyser for prolonged separation. This then frees up the remainder of the body of the analyser which can be used to perform one or more separate, faster (e.g. single pass) analysis/analyses while the zoom mode separation is still ongoing.

To facilitate this, one or more additional trapping deflector(s) are provided and used to divide the drift region of the analyser (with each trapping deflector optionally including a drift focussing lens). Alternatively, in embodiments where the analyser is of the type that includes a set of periodic lenses, one or more of the existing lenses can be used in a corresponding manner to divide the drift region.

Thus, the method comprises injecting a first packet of ions from the ion injector into the space between the ion mirrors, such that the ions follow an ion path having one or more oscillation(s) between the ion mirrors in the direction X whilst drifting in the drift direction Y from the ion injector to the one or more trapping deflector(s) and/or lens(es). The one or more trapping deflector(s) and/or lens(es) are used to cause at least some ions from the first packet of ions to become trapped, during a first time period, in the space between the ion mirrors while completing plural reflections between the ion mirrors. Then, at the end of the first time period, at least some of the ions trapped by the one or more trapping deflector(s) and/or lens(es) are caused to travel from the one or more trapping deflector(s) and/or lens(es) to the detector for detection.

The method also comprises, during the first time period: injecting one or more second packet(s) of ions from the ion injector into the space between the ion mirrors, such that the ions follow an ion path having one or more oscillation(s) between the ion mirrors in the direction X whilst drifting in the drift direction Y from the ion injector to the detector.

The first time period may have any suitable duration. Typically, the analyser is operated with a repetition rate of several tens or a few hundred Hz (e.g. ˜200 Hz), corresponding to a repeating time period having a duration of several ms or a few tens of ms (e.g. ˜5 ms). The duration of the first time period will be greater than the duration of this repeating time period, and so may be on the order of, e.g., several ms, a few tens of ms, several tens of ms, or more.

Each of the one or more second packet(s) of ions may be analysed in either a “normal” single pass mode or a zoom mode. Thus, the method may comprise:
(i) injecting the one or more second packet(s) of ions from the ion injector into the space between the ion mirrors, wherein the ions follow a zigzag ion path having plural reflections between the ion mirrors in the direction X whilst: (a) drifting along the drift direction Y from the first deflector and/or lens towards the second deflector and/or lens, (b) reversing drift direction velocity at the second deflector and/or lens, and (c) drifting back along the drift direction Y to the first deflector and/or lens;
(ii) optionally reversing the drift direction velocity of the ions at the first deflector and/or lens one or more times such that the trapped ions are caused to complete one or more further cycle(s) in which the ions follow a zigzag ion path having plural reflections between the ion mirrors in the direction X whilst: (a) drifting along the drift direction Y from the first deflector and/or lens towards the second deflector and/or lens, (b) reversing drift direction velocity at the second deflector and/or lens, and (c) drifting back along the drift direction Y to the first deflector and/or lens; and
(iii) causing the ions to travel from the first deflector and/or lens to the detector for detection.

In these embodiments, the second deflector and/or lens may be arranged closer to the second end of the ion mirrors than at least one or all of the one or more trapping deflector(s) and/or lens(es), for example such that during the first time period the one or more second packet(s) of ions overlap the ions trapped by the one or more trapping deflector(s) and/or lens(es).

Alternatively, the second deflector and/or lens may be arranged closer to the first end of the ion mirrors than the one or more trapping deflector(s) and/or lens(es), for example wherein the second deflector and/or lens is arranged adjacent to one of the one or more trapping deflector(s) and/or lens(es), for example such that during the first time period the one or more second packet(s) of ions do not overlap the ions trapped by the one or more trapping deflector(s) and/or lens(es).

In some embodiments, the one or more trapping deflector(s) and/or lens(es) comprises a pair of trapping deflectors and/or lenses. Then, the trapped ions may complete plural reflections between the pair of deflectors in the trapping mode.

Thus, the step of using the one or more trapping deflector(s) and/or lens(es) to cause at least some ions to become trapped in the space between the ion mirrors may comprise applying voltages to the pair of trapping deflectors and/or lenses such that:
(i) the trapped ions complete a first cycle in which the ions follow a zigzag ion path having plural reflections between the ion mirrors in the direction X whilst: (a) drifting along the drift direction Y from a first one of the pair of trapping deflectors and/or lenses towards a second one of the pair of trapping deflectors and/or lenses, (b) reversing drift direction velocity at the second one of the pair of trapping deflectors and/or lenses, and (c) drifting back along the drift direction Y to the first one of the pair of trapping deflectors and/or lenses;
(ii) the drift direction velocity of the trapped ions is reversed at the first one of the pair of trapping deflectors and/or lenses such that the trapped ions are caused to complete a further cycle in which the ions follow a zigzag ion path having plural reflections between the ion mirrors in the direction X whilst: (a) drifting along the drift direction Y from the first one of the pair of deflectors and/or lenses towards the second one of the pair of deflectors and/or lenses, (b) reversing drift direction velocity in proximity with the second one of the pair of deflectors and/or lenses, and (c) drifting back along the drift direction Y to the first one of the pair of trapping deflectors and/or lenses; and
(iii) step (ii) is optionally repeated one or more times.

In these embodiments, the analyser may further comprises a compensation electrode extending between the pair of trapping deflectors and/or lenses, and the method may further comprises applying a voltage to the compensation electrode to set the focal plane position of the ions released from the one or more trapping deflector(s) and/or lens(es) to coincide with a surface of the detector.

In some embodiments, the independent trapping region may be incorporated into the main region of the analyser when not in use. Thus, in its normal mode of operation, the analyser may be operated by:
(i) injecting ions from the ion injector into the space between the ion mirrors, wherein the ions follow a zigzag ion path having plural reflections between the ion mirrors in the direction X whilst: (a) drifting along the drift direction Y from the first deflector and/or lens towards the second end of the ion mirrors, (b) reversing drift direction velocity at one of the one or more trapping deflector(s) and/or lens(es) or at the second deflector and/or lens, and (c) drifting back along the drift direction Y to the first deflector and/or lens;
(ii) optionally reversing the drift direction velocity of the ions at the first deflector and/or lens one or more times such that the trapped ions are caused to complete one or more further cycle(s) in which the ions follow a zigzag ion path having plural reflections between the ion mirrors in the direction X whilst: (a) drifting along the drift direction Y from the first deflector and/or lens towards the second end of the ion mirrors, (b) reversing drift direction velocity at one of the one or more trapping deflector(s) and/or lens(es) or at the second deflector and/or lens, and (c) drifting back along the drift direction Y to the first deflector and/or lens; and
(iii) causing the ions to travel from the first deflector and/or lens to the detector for detection.

In further embodiments, the ion injector may be located in proximity with the first end of the ion mirrors, and the detector may be located in proximity with the second end of the ion mirrors. In these embodiments, each of the one or more trapping deflector(s) and/or lens(es) may be located between the first and second ends of the ion mirrors.

In these embodiments, the method may comprise injecting the one or more second packet(s) of ions from the ion injector into the space between the ion mirrors, wherein the ions follow a zigzag ion path having plural reflections between the ion mirrors in the direction X whilst drifting along the drift direction Y to the detector for detection, for example wherein during the first time period the one or more second packet(s) of ions overlap the ions trapped by the one or more trapping deflector(s) and/or lens(es).

In some embodiments, the one or more trapping deflector(s) and/or lens(es) may comprise a plurality of trapping deflectors and/or lenses arranged between the ion mirrors. Then, the method may comprise: using each of the trapping deflectors and/or lenses to cause at least some ions from the first packet of ions to become trapped, during the first time period, in the space between the ion mirrors while completing plural reflections between the ion mirrors.

In some embodiments, the trapping mode may be achieved using a single trapping deflector. In this case, the step of using the one or more trapping deflector(s) and/or lens(es) to cause at least some ions to become trapped in the space between the ion mirrors may comprise using a single trapping deflector and/or lens to trap the at least some ions by:
applying a first voltage to the trapping deflector and/or lens that causes the drift direction velocity of the ions to be reduced to approximately zero, such that ions exit the trapping deflector and/or lens and are reflected from one of the ion mirrors back to the trapping deflector and/or lens; and then
applying a second different voltage to the trapping deflector and/or lens such that the drift direction velocity of the ions is substantially unaffected by the trapping deflector and/or lens, such that ions exit the trapping deflector and/or lens and are reflected from the other one of the ion mirrors back to the trapping deflector and/or lens.

It is believed that this trapping mode is new and advantageous in its own right.

Thus, a further aspect provides a method of operating a multi-reflection time-of-flight (MR-ToF) mass analyser that comprises:
two ion mirrors spaced apart and opposing each other in a first direction X, each mirror elongated generally along a drift direction Y between a first end and a second end, the drift direction Y being orthogonal to the first direction X;
an ion injector for injecting ions into a space between the ion mirrors;
a detector for detecting ions after they have completed a plurality of reflections between the ion mirrors; and
a trapping deflector and/or lens arranged between the ion mirrors;
the method comprising:
injecting a first packet of ions from the ion injector into the space between the ion mirrors;
using the trapping deflector and/or lens to cause at least some ions from the first packet of ions to become trapped in the space between the ion mirrors while completing plural reflections between the ion mirrors; and then
causing at least some of the ions trapped by the trapping deflector and/or lens to travel from the trapping deflector and/or lens to the detector for detection;
wherein the step of using the trapping deflector and/or lens to cause at least some ions to become trapped in the space between the ion mirrors comprises:
   applying a first voltage to the trapping deflector and/or lens that causes the drift direction velocity of the ions to be reduced to approximately zero, such that ions exit the trapping deflector and/or lens and are reflected from one of the ion mirrors back to the deflector and/or lens; and then
   applying a second different voltage to the trapping deflector and/or lens such that the drift direction velocity of the ions is substantially unaffected by the trapping deflector and/or lens, such that ions exit the trapping deflector and/or lens and are reflected from the other one of the ion mirrors back to the trapping deflector and/or lens.

This aspect can, and in embodiments does, include any one or more or each of the optional features described above and elsewhere herein.

In various embodiments, the step of causing at least some of the ions trapped by the trapping deflector and/or lens to travel from the trapping deflector and/or lens to the detector for detection may comprise applying a third different voltage to the trapping deflector and/or lens such that the ions are caused to travel towards the detector.

Upon reaching the detector, ions may be detected by the detector, e.g. their arrival time may be recorded by the detector. The time-of-flight and/or mass to charge ratio of the ions may then be determined, optionally combined with time-of-flight and/or mass to charge ratio information of other ions, and e.g. a mass spectrum may be produced. It should be noted that not all of the ions that were injected into the analyser may be detected by the detector, e.g. due to inevitable losses at various points between the injector and the detector and/or detector inefficiencies. Thus, as used herein the term “the ions” should be understood as meaning “some, most or all of the ions”.

In general, the first packet of ions may comprise a packet of precursor ions, and the method may comprise: detecting at least some ions from the first packet of ions using the detector and generating an MSI mass spectrum for the first packet of ions. Then, each of the one or more second packet(s) of ions may comprise a packet of product ions, and the method may comprise: detecting at least some ions from each second packet of ions using the detector and generating an MS2 mass spectrum for each second packet of ions.

In some embodiments, the method may further comprise fragmenting at least some of the ions while they are trapped by the trapping deflector(s) and/or lens(es).

A further aspect provides a method of operating a multi-reflection time-of-flight (MR-ToF) mass analyser that comprises:

two ion mirrors spaced apart and opposing each other in a first direction X, each mirror elongated generally along a drift direction Y between a first end and a second end, the drift direction Y being orthogonal to the first direction X;
an ion injector for injecting ions into a space between the ion mirrors, the ion injector located in proximity with the first end of the ion mirrors;
a detector for detecting ions after they have completed a plurality of reflections between the ion mirrors, the detector located in proximity with the second end of the ion mirrors;
a first deflector located in proximity with the first end of the ion mirrors; and
a second deflector located in proximity with the second end of the ion mirrors;
the method comprising:
(i) injecting ions from the ion injector into the space between the ion mirrors, wherein the ions complete a first pass through the analyser in which the ions follow a zigzag ion path having plural reflections between the ion mirrors in the direction X whilst drifting along the drift direction Y from the first deflector towards the second deflector;
(ii) using the second deflector to reverse the drift direction velocity of the ions such that the ions are caused to complete a further cycle through the analyser in which the ions follow a zigzag ion path having plural reflections between the ion mirrors in the direction X whilst: (a) drifting along the drift direction Y from the second deflector towards the first deflector, (b) reversing drift direction velocity at the first deflector, and (c) drifting back along the drift direction Y to the second deflector;
(iii) optionally repeating step (ii) one or more times; and then
(iv) causing the ions to travel from the second deflector to the detector for detection.

This aspect can, and in embodiments does, include any one or more or each of the optional features described above and elsewhere herein.

A further aspect provides a non-transitory computer readable storage medium storing computer software code which when executed on a processor performs the method described above.

A further aspect provides a control system for an analytical instrument, the control system configured to cause the analytical instrument to perform the method described above.

A further aspect provides a multi-reflection time-of-flight (MR-ToF) mass analyser comprising:
two ion mirrors spaced apart and opposing each other in a first direction X, each mirror elongated generally along a drift direction Y between a first end and a second end, the drift direction Y being orthogonal to the first direction X;
an ion injector for injecting ions into a space between the ion mirrors;
a detector for detecting ions after they have completed a plurality of reflections between the ion mirrors;
one or more trapping deflector(s) and/or lens(es) arranged between the ion mirrors; and
a control system configured to:
cause a first packet of ions to be injected from the ion injector into the space between the ion mirrors, such that the ions follow an ion path having one or more oscillation(s) between the ion mirrors in the direction X whilst drifting in the drift direction Y from the ion injector to the one or more trapping deflector(s) and/or lens(es);
cause at least some ions from the first packet of ions to become trapped by the one or more trapping deflector(s) and/or lens(es), during a first time period, in the space between the ion mirrors while completing plural reflections between the ion mirrors;
at the end of the first time period, cause at least some of the ions trapped by the one or more trapping deflector(s) and/or lens(es) to travel from the one or more trapping deflector(s) and/or lens(es) to the detector for detection; and
during the first time period: cause one or more second packet(s) of ions to be injected from the ion injector into the space between the ion mirrors, such that the ions follow an ion path having one or more oscillation(s) between the ion mirrors in the direction X whilst drifting in the drift direction Y from the ion injector to the detector.

A further aspect provides a multi-reflection time-of-flight (MR-ToF) mass analyser comprising:
two ion mirrors spaced apart and opposing each other in a first direction X, each mirror elongated generally along a drift direction Y between a first end and a second end, the drift direction Y being orthogonal to the first direction X;
an ion injector for injecting ions into a space between the ion mirrors;
a detector for detecting ions after they have completed a plurality of reflections between the ion mirrors;
a trapping deflector and/or lens arranged between the ion mirrors; and
a control system configured to:
cause a first packet of ions to be injected from the ion injector into the space between the ion mirrors;
cause at least some ions from the first packet of ions to become trapped by the trapping deflector and/or lens in the space between the ion mirrors while completing plural reflections between the ion mirrors; and then
cause at least some of the ions trapped by the trapping deflector and/or lens to travel from the trapping deflector and/or lens to the detector for detection;
wherein the control system is configured to cause at least some ions to become trapped in the space between the ion mirrors by:
   applying a first voltage to the trapping deflector and/or lens that causes the drift direction velocity of the ions to be reduced to approximately zero, such that ions exit the trapping deflector and/or lens and are reflected from one of the ion mirrors back to the deflector and/or lens; and then
   applying a second different voltage to the trapping deflector and/or lens such that the drift direction velocity of the ions is substantially unaffected by the trapping deflector and/or lens, such that ions exit the trapping deflector and/or lens and are reflected from the other one of the ion mirrors back to the trapping deflector and/or lens.

A further aspect provides a multi-reflection time-of-flight (MR-ToF) mass analyser comprising:
two ion mirrors spaced apart and opposing each other in a first direction X, each mirror elongated generally along a drift direction Y between a first end and a second end, the drift direction Y being orthogonal to the first direction X;
an ion injector for injecting ions into a space between the ion mirrors, the ion injector located in proximity with the first end of the ion mirrors;
a detector for detecting ions after they have completed a plurality of reflections between the ion mirrors, the detector located in proximity with the second end of the ion mirrors;
a first deflector located in proximity with the first end of the ion mirrors;
a second deflector located in proximity with the second end of the ion mirrors; and
a control system configured to:
(i) cause ions to be injected from the ion injector into the space between the ion mirrors, wherein the ions complete a first pass through the analyser in which the ions follow a zigzag ion path having plural reflections between the ion mirrors in the direction X whilst drifting along the drift direction Y from the first deflector towards the second deflector;
(ii) cause the second deflector to cause the drift direction velocity of the ions to be reversed such that the ions are caused to complete a further cycle through the analyser in which the ions follow a zigzag ion path having plural reflections between the ion mirrors in the direction X whilst: (a) drifting along the drift direction Y from the second deflector towards the first deflector, (b) reversing drift direction velocity at the first deflector, and (c) drifting back along the drift direction Y to the second deflector;
(iii) optionally cause step (ii) to be repeated one or more times; and
(iv) cause the ions to travel from the second deflector to the detector for detection.

A further aspect provides an analytical instrument, such as a mass spectrometer, comprising:
an ion source;
the control system described above; and/or
the multi-reflection time-of-flight mass analyser described above.

These aspects can, and in embodiments do, include any one or more or each of the optional features described above and elsewhere herein.

The mass spectrometer may comprise an ion source. Ions may be generated from a sample in the ion source. The ions may be passed from the ion source to the analyser via one or more ion optical devices arranged between the ion source and the analyser.

The one or more ion optical devices may comprise any suitable arrangement of one or more ion guides, one or more lenses, one or more gates, and the like. The one or more ion optical devices may include one or more transfer ions guides for transferring ions, and/or one or more mass selector or filters for mass selecting ions, and/or one or more ion cooling ion guides for cooling ions, and/or one or more collision or reaction cells for fragmenting or reacting ions, and so on. One or more or each ion guide may comprise a multipole ion guide such as a quadrupole ion guide, hexapole ion guide, etc., a segmented multipole ion guide, a stacked ring type ion guide, and the like.

### BRIEF DESCRIPTION OF THE DRAWINGS

Various embodiments will now be described in more detail with reference to the accompanying Figures, in which:

FIG. 1 shows schematically a mass spectrometer in accordance with embodiments;

FIG. 2 shows schematically a multi-reflection time-of-flight (MR-ToF) mass analyser;

FIG. 3 shows schematically a deflector for a multi-reflection time-of-flight mass analyser in accordance with embodiments;

FIG. 4 shows schematically a multi-reflection time-of-flight (MR-ToF) mass analyser in accordance with embodiments;

FIG. 5 illustrates schematically a method of operating a deflector for a multi-reflection time-of-flight mass analyser in accordance with embodiments;

FIG. 6 shows schematically a multi-reflection time-of-flight (MR-ToF) mass analyser configured in accordance with embodiments;

FIG. 7 shows schematically a multi-reflection time-of-flight (MR-ToF) mass analyser configured in accordance with embodiments;

FIG. 8 shows schematically a multi-reflection time-of-flight (MR-ToF) mass analyser configured in accordance with embodiments; and

FIG. 9 shows schematically a multi-reflection time-of-flight (MR-ToF) mass analyser configured in accordance with embodiments.

### DETAILED DESCRIPTION

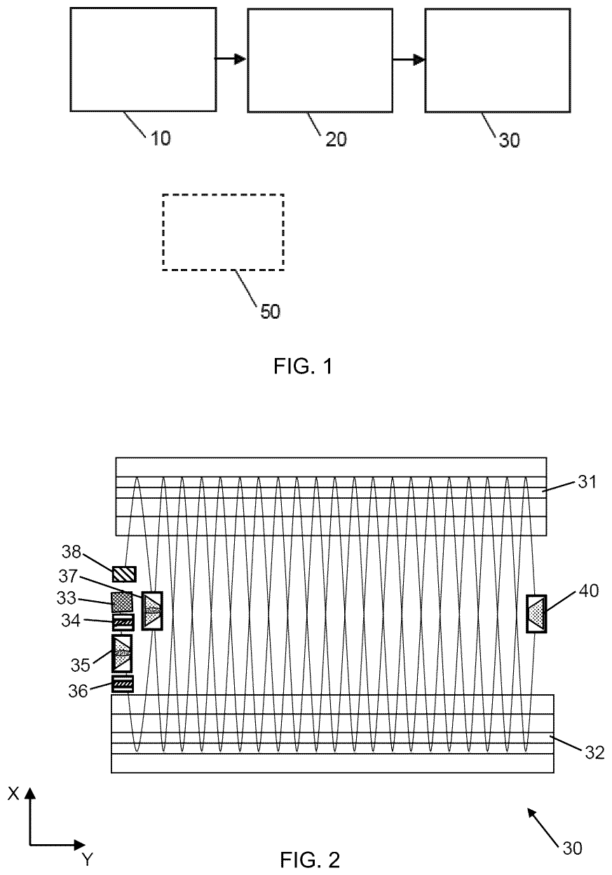

FIG. 1 illustrates schematically a mass spectrometer that may be operated in accordance with embodiments. As shown in FIG. 1, the mass spectrometer includes an ion source 10, one or more ion transfer stages 20, and a multi-reflection time-of-flight (MR-ToF) mass analyser 30.

The ion source 10 is configured to generate ions from a sample. The ion source 10 can be any suitable continuous or pulsed ion source, such as an electrospray ionisation (ESI) ion source, a MALDI ion source, an atmospheric pressure ionisation (API) ion source, a plasma ion source, an electron ionisation ion source, a chemical ionisation ion source, and so on. More than one ion source may be provided and used. The ions may be any suitable type of ions to be analysed, e.g. small and large organic molecules, biomolecules, DNA, RNA, proteins, peptides, fragments thereof and the like.

The ion source 10 may be coupled to a separation device such as a liquid chromatography separation device or a capillary electrophoresis separation device (not shown), such that the sample which is ionised in the ion source 10 comes from the separation device.

The ion transfer stage(s) 20 are arranged downstream of the ion source 10 and may include an atmospheric pressure interface and one or more ion guides, lenses and/or other ion optical devices configured such that some or all of the ions generated by the ion source 10 can be transferred from the ion source 10 to the analyser 30. The ion transfer stage(s) 20 may include any suitable number and configuration of ion optical devices, for example optionally including one or more RF and/or multipole ion guides, one or more ion guides for cooling ions, one or more mass selective ion guides, and so on.

The mass analyser 30 is arranged downstream of the ion transfer stage(s) 20 and is configured to receive ions from the ion transfer stage(s) 20. The mass analyser is configured to analyse the ions so as to determine their mass to charge ratio and/or mass, i.e. to produce a mass spectrum of the ions. The mass analyser 30 is a multi-reflecting time-of-flight (MR-ToF) mass analyser (as described further below).

It should be noted that FIG. 1 is merely schematic, and that the mass spectrometer can, and in embodiments does, include any number of one or more additional components. For example, in particular embodiments, the mass spectrometer includes a collision or reaction cell. The instrument may include a single mass analyser, or more than one (e.g. two) mass analysers.

As also shown in FIG. 1, the mass spectrometer is under the control of a control unit 50, such as an appropriately programmed computer, which controls the operation of various components of the spectrometer and, for example, sets the voltages to be applied to the various components of the spectrometer including the analyser 30. The control unit 50 may also receive and process data from various components including the detector(s).

FIG. 2 illustrates schematically a multi-reflection time-of-flight (MR-ToF) mass analyser 30 of the type described in UK patent No. GB 2,580,089, the content of which is incorporated herein by reference. As shown in FIG. 2, the analyser 30 includes a pair of ion mirrors 31, 32 that are spaced apart and face each other in a first direction X. The ion mirrors 31, 32 are elongated between a first end and a second end along an orthogonal drift direction Y.

An ion source (injector) 33, which may be in the form of an ion trap, is arranged at one end (the first end) of the analyser. The ion source 33 may be arranged and configured to receive ions from the ion transfer stage(s) 20. Ions may be accumulated in the ion source 33, before being injected into the space between the ion mirrors 31, 32. As shown in FIG. 2, ions may be injected from the ion source 33 with a relatively small injection angle or drift direction velocity, creating a zig-zag ion trajectory, whereby different oscillations between the mirrors 31, 32 are separate in space.

One or more lenses and/or deflectors may be arranged along the ion path, between the ion source 33 and the ion mirror 32 first encountered by the ions. For example, as shown in FIG. 2, a first out-of-plane lens 34, an injection deflector 35, and a second out-of-plane lens 36 may be arranged along the ion path, between the ion source 33 and the ion mirror 32 first encountered by the ions. Other arrangements would be possible. In general, the one or more lenses and/or deflectors may be configured to suitably condition, focus and/or deflect the ion beam, i.e. such that it is caused to adopt the desired trajectory through the analyser 30.

The analyser also includes another deflector (a “first deflector”) 37 in proximity with the first end of the ion mirrors 31, 32 which is arranged along the ion path, between the ion mirrors 31, 32. As shown in FIG. 2, the first deflector 37 may be arranged approximately equidistant between the ion mirrors 31, 32, along the ion path after its first ion mirror reflection (in ion mirror 32), and before its second ion mirror reflection (in the other ion mirror 31).

The analyser also includes a detector 38, which may be arranged in proximity with the first end of the ion mirrors 31, 32. The detector 38 may be any suitable ion detector configured to detect ions, and e.g. to record an intensity and time of arrival associated with the arrival of ion(s) at the detector. Suitable detectors include, for example, one or more conversion dynodes, optionally followed by one or more electron multipliers, and the like.

In its “normal” mode of operation, ions are injected from the ion source 33 into the space between the ion mirrors 31, 32, in such a way that the ions adopt a zigzag ion path having plural reflections between the ion mirrors 31, 32 in the X direction, whilst: (a) drifting along the drift direction Y from the first deflector 37 towards the opposite (second) end of the ion mirrors 31, 32, (b) reversing drift direction velocity in proximity with the second end of the ion mirrors 31, 32, and then (c) drifting back along the drift direction Y to the first deflector 37. The ions are then caused to travel from the first deflector 37 to the detector 38 for detection.

In the analyser depicted in FIG. 2, the ion mirrors 31, 32 are parallel to each other. In order to cause the ions to reverse their drift direction velocity in proximity with the second end of the ion mirrors and drift back along the drift direction towards the first deflector 37, the analyser includes a second deflector 40 at the second end of the ion mirrors 31, 32. Application of a suitable voltage to the second deflector 40 causes the drift direction velocity of the ions to be reversed by the second deflector 40.

As also shown in FIG. 2, a lens can be included in the injection deflector 35 and/or in the first deflector 37. The ion beam is allowed to expand a short way into the analyser before meeting a long-focus lens, which has the effect of focussing the ion beam along its length. The lens may be an elliptical drift focusing (converging) lens mounted within the deflector 37. The second deflector 40 can optionally also include a lens which may be used to maintain control of focal properties when the beam direction is reversed.

Further detail of the single-lens type multireflection time-of-flight mass analyser of FIG. 2 is given in UK patent No. GB 2,580,089, the content of which is incorporated herein by reference.

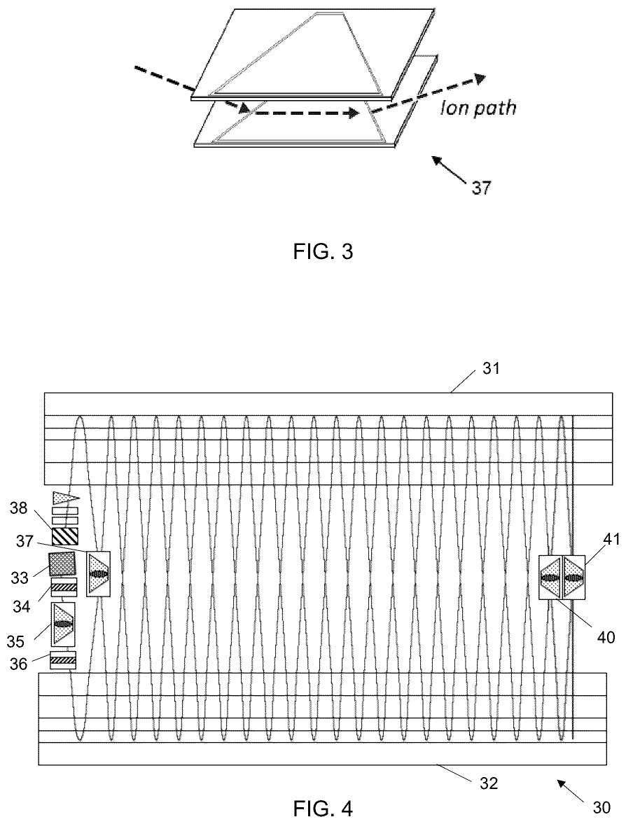

In this class of analyser, the ion beam is relatively broad in the drift dimension Y, often around 10 mm, depending on the focal quality. This leads to a need for the deflectors 37, 40 to be able to accept a wide beam without introducing clipping or uneven deflection. As shown in FIG. 3, a suitable deflector design is a trapezoid shaped or prism-like deflector. Each deflector 37, 40 may comprise a trapezoid shaped or prism-like electrode arranged above the ion beam and another trapezoid shaped or prism-like electrode arranged below the ion beam. The electrodes are angled with respect to the ion beam. Ions experience a relatively strong electric field at the edges of the angled electrodes, inducing a deflection. The electrodes are located out-of-plane of the deflection, thereby allowing them to be easily made to be broad enough to accept a wide ion beam (at least compared to more conventional deflection plates that would sit at either side of the beam).

The angle of deflection given to the ions by the deflector can be controlled by controlling a voltage applied to the deflector. The magnitude of the voltage applied to the deflector may be switched between various levels to deflect ions by different angles. To do this, the power supply driving the deflector should be very fast. Suitable solution power supplies are described, for example, in UK patent No. GB 2,617,229, the content of which is incorporated herein by reference.

Although the MR-ToF analyser 30 depicted in FIG. 2 is particularly suitable for the methods described herein, various other forms of MR-ToF analyser 30 could be used. For example, the analyser could be of the type described in the article A. Verenchikov, et al., Journal of Applied Solution Chemistry and Modelling, 2017, 6, 1-22. Here, the MR-ToF analyser includes a set of periodic lenses that function to keep the ion beam focused along its flight path. In contrast, in the analyser of FIG. 2, the ion beam is allowed to spread out relatively broadly for most of its flight path. A significant advantage of allowing the ion beam to spread out broadly for most of its flight path is that space charge effects are reduced, which can be a significant problem for time-of-flight analysers. Nevertheless, embodiments described herein are also applicable to other MR-ToF analyser designs, such as the Verenchikov-type MR-ToF analyser.

It can be desirable to increase the resolution of the analyser, both to increase the separation of analyte ions and to improve their accurate mass assignment. Generally, an MR-ToF analyser's resolution is limited by the length of the ion flight path through the analyser, and the arrival time spread of ions at the detector. Longer ion flight paths allow higher resolution. For low m/z ions, this benefit is particularly important as it minimises the impact of the detector time response that normally causes a substantial drop off in resolution at lower m/z.

To do this, the analyser 30 can be operated in a multi-pass “zoom” mode, e.g. as described in UK patent No. GB 2,617,229, the content of which is incorporated herein by reference. In this mode of operation, the first deflector 37 at the front of the analyser, which is normally used to reduce the injection angle and/or optimise the number (K) of oscillations within a single drift pass, is used to enable a multi-pass “zoom” mode of operation. By applying an appropriate voltage to the first deflector 37, the drift direction velocity of ions is reversed by the first deflector 37 when they return from the second deflector 40, so that ions are caused to complete plural cycles within the analyser. In each cycle the ions drift in the drift direction Y from the first deflector 37 towards the opposite (second) end of the ion mirrors (i.e. to the second deflector 40), and then back to the first deflector 37. After the ions have completed the desired (plural) number of cycles within the analyser, the ions are allowed to travel from the first deflector 37 to the detector 38 for detection, e.g. by altering the voltage applied to the first deflector 37 such that the ions are caused to exit the deflector 37 in a direction towards the detector 38.

This “zoom” mode of operation beneficially has the effect of increasing the length of the ion path taken by ions within the analyser (between the injector 33 and the detector 38), thereby increasing the resolution of the analyser. However, this comes at the cost of increased ion residence time within the analyser, during which time no new packets of ions can be analysed by the analyser 30.

Embodiments of the present disclosure provide a method of operating an MR-ToF analyser in a “zoom” mode where the ions trapped in the zoom mode do not take up the entire body of the analyser but are instead confined to one region of the analyser for prolonged separation. This then frees up the remainder of the body of the analyser which can be used to perform a separate, faster (e.g. single pass) analysis while the zoom mode separation is still ongoing.

To facilitate this, one or more additional deflector(s) are provided and used to divide the drift region of the analyser 30. Each additional deflector may have the design described above and depicted in FIG. 3. In addition, one or more drift focusing lens(es) may be provided and used as needed to prevent excessive dispersion. In embodiments where the analyser is of the type that includes a set of periodic lenses, one or more of the existing lenses can be used in a corresponding manner to divide the drift region.

FIG. 4 shows an embodiment, whereby an additional (“third”) deflector 41 is located at the far (“second”) end of the drift region, adjacent to the existing second deflector 40. All other components shown in FIG. 4 correspond to those shown in FIG. 2, and so will not be described again. In FIG. 4, both the second deflector 40 and the third deflector 41 are shown as including a respective drift lens, but one or both of these drift lenses are optional.

Like the first 37 and second 40 deflectors, the magnitude of a voltage applied to the third deflector 41 can be adjusted to control the angle of deflection given to ions as they pass through the third deflector. This allows a “trapping” zoom mode whereby selected ions are diverted to an independent trapping region, while allowing the main bulk of the ToF analyser to be operated in parallel.

In this trapping mode of operation, the farthest (third) deflector 41 is used to trap ions. A voltage applied to the third deflector 41 is switched to a drift stopping mode before the desired ions approach, and then rapidly switches back to the analyser potential, a trapping mode, before they re-enter (via a reflection in one of the mirrors 31,32).

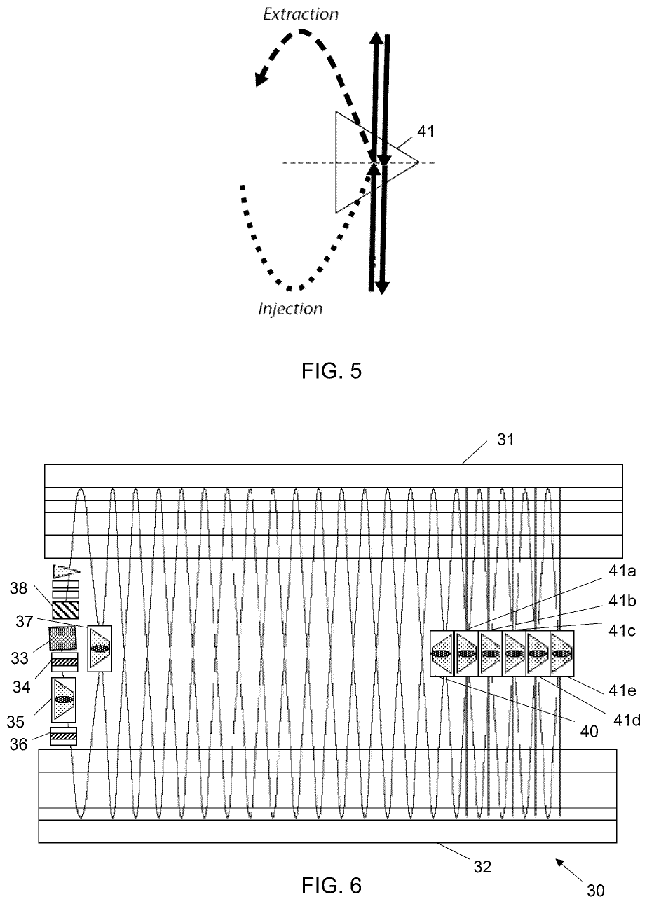

In other words, and as illustrated by FIG. 5, the third deflector 41 is set to a voltage that removes the ions' drift velocity. Then, the ions pass from the third deflector 41 into one of the mirrors and are reflected straight back into the third deflector 41. As the voltage applied to the third deflector 41 has at this point been changed to the analyser potential, the third deflector 41 does not deflect the ions, and the ions pass straight through the third deflector 41 and into the other one of the mirrors and are reflected straight back into the third deflector 41. Thus, ions trapped in the independent trapping region provided by the third deflector 41 are reflected in the X direction between the ion mirrors 31, 32 multiple times.

In this mode of operation, ion access is controlled by gating the deflector 41 voltage (though additional faster gates may be used). Ions that get ahead of this gating will largely pass back to the ion trap 33. Ions trapped in the independent trapping region provided by the third deflector 41 are reflected between the ion mirrors 31, 32 multiple times, until they are released (extracted) towards the detector 38 by applying an appropriate voltage to the third deflector 41.

Returning to FIG. 4, the provision of the second deflector 40 allows the remainder of the body of the analyser 30 to be used to analyse another packet of ions while the first packet of ions is trapped in the independent trapping region. Thus, for example, another packet of ions can be injected into the analyser from the ion source 33 and analysed by the analyser, e.g. in a normal single pass mode (where ions travel from the first deflector 37 to the detector 38 via the second deflector 40) or even in a zoom mode where ions are reflected between the first 37 and second 40 deflectors multiple times before being released to the detector 38.

In some embodiments, the independent drift trapping region may be merged into the main region of the analyser when it is not in use, thereby lengthening the main region of the analyser and improving its resolution (but shifting tune and calibration). Thus, the analyser of FIG. 4 may be operated in a “normal” mode of operation (or a conventional “zoom” mode of operation) whereby ions travel from the first deflector 37 to the detector 38 via either the second deflector 40 or the third deflector 41.

As also shown in FIG. 4, the independent drift trapping region provided by the third deflector 41 may have a drift focusing lens, e.g. operating at a low potential (e.g., a few volts), suited to keeping the collimated beam stable. If there is no such lens the ions may have to be extracted either to a drift focusing lens, or the detector 38, before the beam dispersion expands beyond desired limits.

Although the embodiment depicted by FIG. 4 has a single independent trapping region provided by the third deflector 41, it would be possible for the analyser to comprise multiple such trapping regions, each of which may be defined by its own deflector (and/or lens). FIG. 6 shows an example embodiment of an analyser 30 having an array of up to five independent trapping regions, where each independent trapping region is defined by a respective deflector 41a, 41b, 41c, 41d, 41e. Although FIG. 6 shows an embodiment having five independent trapping regions, it will be understood that any number of trapping regions could be provided.

Each of the deflectors 41a, 41b, 41c, 41d, 41e may be configured as described above in relation to FIG. 3 and may be operated to trap ions in the manner described above with respect to FIG. 5. In operation, the plural trapping regions may be filled up (and emptied) sequentially, or by catching and storing different parts of the m/z range of a single packet of ions (which will separate spatially according to the ions' m/z as the ions travel though the MR-ToF analyser) in different trapping regions.

Although in the embodiments described so far, each trapping region is defined by a single deflector whereby the ions make multiple reflections between the ion mirrors 31, 32 in the first (X) direction, other trapping modes are possible. In general, the or each independent trapping region may have any size and may comprise any proportion of the analyser.

For example, in some embodiments, the independent trapping region may comprise a relatively wide region of the analyser 30, where ions make multiple spatially separated oscillations (in a zig-zag pattern) while being trapped in the trapping region. Wider trapping regions reduce the lapping of higher m/z ions by those of lower m/z, and thus improves the certainty at which m/z may be assigned. However, this comes at the cost of increased drift space.

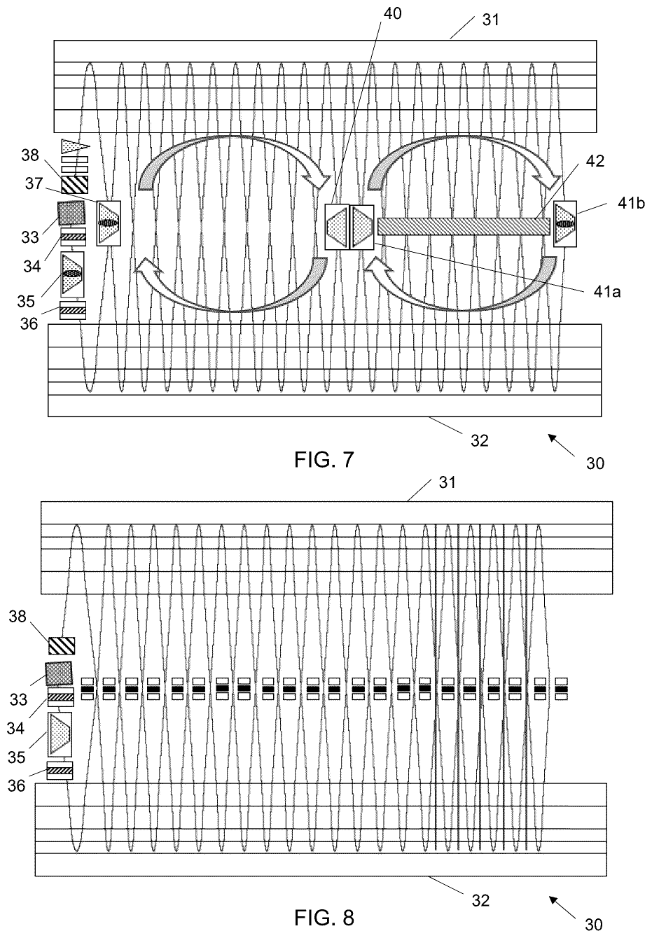

FIG. 7 shows an example embodiment in which approximately half of the drift region of the analyser is allocated for the independent trapping region. It would of course be possible for the independent trapping region to take up any other suitable proportion of the analyser. As shown in FIG. 7, the second deflector 40 is located close to the centre (in the drift direction Y) of the analyser, while two additional deflectors 41a, 41b are provided, a first 41a adjacent to the second deflector 40 and a second 41b at the second end of the analyser. Ions may be trapped in an independent trapping zoom mode between the two additional deflectors 41a, 41b, while allowing the remainder of the ToF analyser (between the first deflector 37 and the second deflector 40) to be operated in parallel.

By applying appropriate voltages to the additional deflectors 41a, 41b, the drift direction velocity of ions may be reversed by each of the additional deflectors 41a, 41b, so that ions are caused to complete plural cycles between the additional deflectors 41a, 41b. In each cycle, the ions drift in the drift direction Y from the first additional deflector 41a towards the second additional deflector 41b, and then back to the first additional deflector 41a while making multiple reflections in the X direction between the ion mirrors 31, 32. After the ions have completed a desired (e.g., plural) number of cycles between the additional deflectors 41a, 41b, the ions are allowed to travel from the first additional deflector 41a to the detector 38 for detection, e.g. by altering the voltage applied to the first additional deflector 41a such that the ions are caused to exit the first additional deflector 41a in a direction towards the detector 38.

Similarly to the embodiments depicted by FIGS. 4 and 6, in these embodiments, the remainder of the body of the analyser 30 may be used to analyse another packet of ions while the first packet of ions is trapped in the independent trapping region. Thus, for example, another packet of ions can be injected into the analyser from the ion source 33 and analysed by the analyser, e.g. in a normal single pass mode (where ions travel from the first deflector 37 to the detector 38 via the second deflector 40) or in a zoom mode where ions are reflected between the first 37 and second 40 deflectors multiple times before being released to the detector 38.

In FIG. 7, an optional correction stripe electrode 42 is shown, which runs through the centre of the independent drift trapping region (i.e. between the additional deflectors 41a, 41b). It would also or instead be possible for the primary drift region to include a correction stripe electrode (i.e. between the first deflector 37 and the second deflector 40). The (or each) correction stripe electrode 42 extends along at least a portion of the drift direction (Y) in or adjacent to the space between the mirrors 31, 32.

As is described in more detail in co-pending UK patent application No. GB2312458.9, the content of which is incorporated herein by reference, the stripe electrode 42 is included to control the focal plane position of the ion beam. The correction stripe electrode 42 may have a (relatively low) potential applied to it, to shift the focal plane position of the ion beam so that ions emerging from the independent trapping region to the detector 38 will share a focal plane with ions analysed using only the primary drift region. This can be done without having to retune the slowly responding mirror or detector voltages.

One particularly suitable application for the trapping modes described herein, particularly for the analyser depicted by FIG. 7, is to perform a high resolution MS1 scan using the independent trapping zoom mode, optionally with >1 ion packet injections per spectra with differing timing, to allow unambiguous m/z assignment, e.g.

as described in UK patent application No. GB 2,616,595, the content of which is incorporated herein by reference. Simultaneous to this super-high resolution multi-pass MS1 scan, multiple lower resolution but highly sensitive MS2 scans may be acquired using the primary drift region of the analyser.

In these embodiments, tracking of flight times may be relatively complicated.

Optionally more than digitiser/detector may be used, or some other means of accurately retaining and comparing multiple trigger times for the various ion populations may be provided.

Various alternatives are possible.

For example, in the embodiments depicted by FIGS. 4 and 6, because the trapping deflector 41 is in effect deactivated once ions are trapped, it is possible to have trapping region(s) overlap with the primary drift region, and to allow ions to be measured simultaneously in the same drift space as trapped ions are being separated. However, these embodiments may need a periodic lens at every oscillation (with deflection functionality built in), suited to focusing both trapped and normally analysed ions. FIG. 8 shows an example embodiment of a periodic lens-type MR-ToF analyser where each lens has an independently switchable deflector, allowing massive simultaneous analysis with a superimposed normal mode. Such a mode of operation is potentially advantageous as many zoom regions may be used; even, say, twenty in a 1 m² analyser, and ions may be accumulated and/or analysed sequentially.

In some embodiments, the independent drift region may contain a collision cell or some other fragmentation device, e.g. for ToF-MS/MS fragmentation.

The method of using deflectors within the drift region described herein can also allow variation of the single-pass ion path length. This may be done, for example, to limit gas collisions for fragile or high mass ions. In the embodiments depicted in FIGS. 4, 6 and 7, the process of initial beam expansion is encouraged by a first drift focusing lens provided in the first deflector 37. Another way to achieve this is by introducing curvature to some other existing element. An ideal candidate for this is the plate immediately ahead of the extraction trap 33. This space typically has a 4 KV potential difference relative to the trap and is responsible for the bulk of ion acceleration. Adding curvature to this strong field produces a strong lensing effect, sufficient to cause rapid expansion of the ion cloud. A 20 mm radius curve, penetrating 3 mm into the electrode, allows an initially 2 mm wide beam to completely fill the open region of the collimating lens. Similarly, a 30 mm radius cutting 1 mm into the electrode doubles the beam width at the point of the collimating lens. Tuning the instrument is more challenging without a dedicated tuneable lens, but in this case, it is unlikely to change substantially from instrument to instrument.

In some embodiments, the zoom mode focusing lens and its deflector 41 need not share an assembly (although this is somewhat more convenient for construction and for instrument tuning). For example, the lens may be substantially offset from the deflector 41 so as to affect the ions at a different number of reflections, and may also not necessarily be located on the central drift axis.

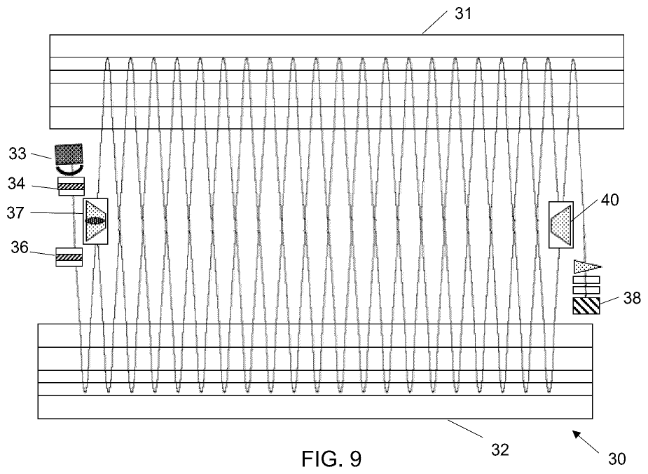

FIG. 9 shows another embodiment of an MR-TOF analyser, where the detector 38 (with tilt correction) is provided at the far (“second”) end of the drift region. Although in this configuration, the shorter ion path length is a drawback, this design allows more space for the injection optics, and thus a shallower injection angle (and so more reflections) becomes possible. This in turn means that the deflector 37 may be normally operated at a low or zero relative potential.

In this embodiment, one or more additional deflectors cans be provided (not shown in FIG. 9), e.g. between the first 37 and second 40 deflectors, and operated in a corresponding manner to define an independent trapping region as described above.

Furthermore, with this analyser design, a short zoom mode becomes possible, whereby the ions make 1.5 full loops of the drift path, i.e. by travelling from the first deflector 37 to the second deflector 40, back to the first deflector 37, and finally to the detector 38 via the second deflector 40. Such a mode of operation has about two to five times the unambiguous mass range as a regular two pass zoom mode, whilst achieving almost as much resolution.

Equally, with this analyser design a 2.5, 3.5, 4.5, etc. zoom mode is possible.

Although the present invention has been described with reference to various embodiments, it will be understood that various changes may be made without departing from the scope of the invention as set out in the accompanying claims.

1. A method of operating a multi-reflection time-of-flight (MR-ToF) mass analyser that comprises:
two ion mirrors spaced apart and opposing each other in a first direction X, each mirror elongated generally along a drift direction Y between a first end and a second end, the drift direction Y being orthogonal to the first direction X;
an ion injector for injecting ions into a space between the ion mirrors;
a detector for detecting ions after they have completed a plurality of reflections between the ion mirrors;
a first deflector and/or lens arranged between the ion mirrors and located in proximity with the first end of the ion mirrors;
a second deflector and/or lens arranged between the ion mirrors and located either in proximity with the second end of the ion mirrors or between the first and second ends of the ion mirrors; and
one or more trapping deflector(s) and/or lens(es) arranged between the ion mirrors and located either in proximity with the second end of the ion mirrors or between the first and second ends of the ion mirrors;
wherein the method comprises:
injecting a first packet of ions from the ion injector into the space between the ion mirrors, such that the ions follow an ion path having one or more oscillation(s) between the ion mirrors in the direction X whilst drifting in the drift direction Y from the ion injector to the one or more trapping deflector(s) and/or lens(es);
using the one or more trapping deflector(s) and/or lens(es) to cause at least some ions from the first packet of ions to become trapped, during a first time period, in the space between the ion mirrors while completing plural reflections between the ion mirrors; and
at the end of the first time period, causing at least some of the ions trapped by the one or more trapping deflector(s) and/or lens(es) to travel from the one or more trapping deflector(s) and/or lens(es) to the detector for detection;
wherein the method further comprises:
during the first time period: injecting one or more second packet(s) of ions from the ion injector into the space between the ion mirrors, such that the ions follow an ion path having one or more oscillation(s) between the ion mirrors in the direction X whilst drifting in the drift direction Y from the ion injector to the detector.

2. The method of claim 1, wherein:
the ion injector is located in proximity with the first end of the ion mirrors; and
the detector is located in proximity with the first end of the ion mirrors.

3. The method of claim 2, wherein the method comprises:
(i) injecting the one or more second packet(s) of ions from the ion injector into the space between the ion mirrors, wherein the ions follow a zigzag ion path having plural reflections between the ion mirrors in the direction X whilst: (a) drifting along the drift direction Y from the first deflector and/or lens towards the second deflector and/or lens, (b) reversing drift direction velocity at the second deflector and/or lens, and (c) drifting back along the drift direction Y to the first deflector and/or lens;
(ii) optionally reversing the drift direction velocity of the ions at the first deflector and/or lens one or more times such that the trapped ions are caused to complete one or more further cycle(s) in which the ions follow a zigzag ion path having plural reflections between the ion mirrors in the direction X whilst: (a) drifting along the drift direction Y from the first deflector and/or lens towards the second deflector and/or lens, (b) reversing drift direction velocity at the second deflector and/or lens, and (c) drifting back along the drift direction Y to the first deflector and/or lens; and
(iii) causing the ions to travel from the first deflector and/or lens to the detector for detection.

4. The method of claim 3, wherein the second deflector and/or lens is arranged closer to the second end of the ion mirrors than at least one or all of the one or more trapping deflector(s) and/or lens(es), optionally such that during the first time period the one or more second packet(s) of ions overlap the ions trapped by the one or more trapping deflector(s) and/or lens(es).

5. The method of claim 3, wherein the second deflector and/or lens is arranged closer to the first end of the ion mirrors than the one or more trapping deflector(s) and/or lens(es), optionally wherein the second deflector and/or lens is arranged adjacent to one of the one or more trapping deflector(s) and/or lens(es), optionally such that during the first time period the one or more second packet(s) of ions do not overlap the ions trapped by the one or more trapping deflector(s) and/or lens(es).

6. The method of claim 2, further comprising operating the analyser in another mode of operation that comprises:
(i) injecting ions from the ion injector into the space between the ion mirrors, wherein the ions follow a zigzag ion path having plural reflections between the ion mirrors in the direction X whilst: (a) drifting along the drift direction Y from the first deflector and/or lens towards the second end of the ion mirrors, (b) reversing drift direction velocity at one of the one or more trapping deflector(s) and/or lens(es) or at the second deflector and/or lens, and (c) drifting back along the drift direction Y to the first deflector and/or lens;
(ii) optionally reversing the drift direction velocity of the ions at the first deflector and/or lens one or more times such that the trapped ions are caused to complete one or more further cycle(s) in which the ions follow a zigzag ion path having plural reflections between the ion mirrors in the direction X whilst: (a) drifting along the drift direction Y from the first deflector and/or lens towards the second end of the ion mirrors, (b) reversing drift direction velocity at one of the one or more trapping deflector(s) and/or lens(es) or at the second deflector and/or lens, and (c) drifting back along the drift direction Y to the first deflector and/or lens; and
(iii) causing the ions to travel from the first deflector and/or lens to the detector for detection.

7. The method of claim 1, wherein:
the ion injector is located in proximity with the first end of the ion mirrors;
the detector is located in proximity with the second end of the ion mirrors; and
each trapping deflector and/or lens is located between the first and second ends of the ion mirrors.

8. The method of claim 7, wherein the method comprises injecting the one or more second packet(s) of ions from the ion injector into the space between the ion mirrors, wherein the ions follow a zigzag ion path having plural reflections between the ion mirrors in the direction X whilst drifting along the drift direction Y to the detector for detection, optionally wherein during the first time period the one or more second packet(s) of ions overlap the ions trapped by the one or more trapping deflector(s) and/or lens(es).

9. The method of claim 1, wherein:
the one or more trapping deflector(s) and/or lens(es) comprise a pair of trapping deflectors and/or lenses; and
the step of using the one or more trapping deflector(s) and/or lens(es) to cause at least some ions to become trapped in the space between the ion mirrors comprises applying voltages to the pair of trapping deflectors and/or lenses such that:
(i) the trapped ions complete a first cycle in which the ions follow a zigzag ion path having plural reflections between the ion mirrors in the direction X whilst: (a) drifting along the drift direction Y from a first one of the pair of trapping deflectors and/or lenses towards a second one of the pair of trapping deflectors and/or lenses, (b) reversing drift direction velocity at the second one of the pair of trapping deflectors and/or lenses, and (c) drifting back along the drift direction Y to the first one of the pair of trapping deflectors and/or lenses;
(ii) the drift direction velocity of the trapped ions is reversed at the first one of the pair of trapping deflectors and/or lenses such that the trapped ions are caused to complete a further cycle in which the ions follow a zigzag ion path having plural reflections between the ion mirrors in the direction X whilst: (a) drifting along the drift direction Y from the first one of the pair of deflectors and/or lenses towards the second one of the pair of deflectors and/or lenses, (b) reversing drift direction velocity in proximity with the second one of the pair of deflectors and/or lenses, and (c) drifting back along the drift direction Y to the first one of the pair of trapping deflectors and/or lenses; and
(iii) step (ii) is optionally repeated one or more times.

10. The method of claim 9, wherein:
the analyser further comprises a compensation electrode extending between the pair of trapping deflectors and/or lenses; and
the method further comprises applying a voltage to the compensation electrode to set a focal plane position of the ions released from the one or more trapping deflector(s) and/or lens(es) to coincide with a surface of the detector.

11. The method of claim 1, wherein:
the one or more trapping deflector(s) and/or lens(es) comprise a plurality of trapping deflectors and/or lenses arranged between the ion mirrors; and
the method comprises: using each of the trapping deflectors and/or lenses to cause at least some ions from the first packet of ions to become trapped, during the first time period, in the space between the ion mirrors while completing plural reflections between the ion mirrors.

12. The method of claim 1, wherein the step of using the one or more trapping deflector(s) and/or lens(es) to cause at least some ions to become trapped in the space between the ion mirrors comprises using a single trapping deflector and/or lens to trap the at least some ions by:
applying a first voltage to the trapping deflector and/or lens that causes a drift direction velocity of the ions to be reduced to approximately zero, such that ions exit the trapping deflector and/or lens and are reflected from one of the ion mirrors back to the trapping deflector and/or lens; and then
applying a second different voltage to the trapping deflector and/or lens such that the drift direction velocity of the ions is substantially unaffected by the trapping deflector and/or lens, such that ions exit the trapping deflector and/or lens and are reflected from the other one of the ion mirrors back to the trapping deflector and/or lens.

13. The method of claim 12, wherein the step of causing at least some of the ions trapped by the trapping deflector and/or lens to travel from the trapping deflector and/or lens to the detector for detection comprises applying a third different voltage to the trapping deflector and/or lens such that the ions are caused to travel towards the detector.

14. The method of claim 1, wherein:
the first packet of ions comprises a packet of precursor ions, and the method comprises: detecting at least some ions from the first packet of ions using the detector and generating an MS1 mass spectrum for the first packet of ions; and
each of the one or more second packet(s) of ions comprises a packet of product ions, and the method comprises: detecting at least some ions from each second packet of ions using the detector and generating an MS2 mass spectrum for each second packet of ions.

15. The method of claim 1, further comprising fragmenting at least some of the ions while they are trapped by the trapping deflector(s) and/or lens(es).

16. The method of claim 1, wherein:
one or more or each deflector comprises one or more trapezoid shaped or prism-like electrodes arranged adjacent to the ion beam; and/or
one or more or each deflector comprises a drift focusing lens configured to focus ions in the drift direction Y.

17. A non-transitory computer readable storage medium storing computer-executable instructions for performing the method of claim 1.

18. A control system for an analytical instrument, the control system configured to cause the analytical instrument to perform the method of claim 1.

19. A multi-reflection time-of-flight (MR-ToF) mass analyser comprising:
two ion mirrors spaced apart and opposing each other in a first direction X, each mirror elongated generally along a drift direction Y between a first end and a second end, the drift direction Y being orthogonal to the first direction X;
an ion injector for injecting ions into a space between the ion mirrors;
a detector for detecting ions after they have completed a plurality of reflections between the ion mirrors;
a first deflector and/or lens arranged between the ion mirrors and located in proximity with the first end of the ion mirrors;
a second deflector and/or lens arranged between the ion mirrors and located either in proximity with the second end of the ion mirrors or between the first and second ends of the ion mirrors;
one or more trapping deflector(s) and/or lens(es) arranged between the ion mirrors and located either in proximity with the second end of the ion mirrors or between the first and second ends of the ion mirrors; and
a control system configured to:
cause a first packet of ions to be injected from the ion injector into the space between the ion mirrors, such that the ions follow an ion path having one or more oscillation(s) between the ion mirrors in the direction X whilst drifting in the drift direction Y from the ion injector to the one or more trapping deflector(s) and/or lens(es);
cause at least some ions from the first packet of ions to become trapped by the one or more trapping deflector(s) and/or lens(es), during a first time period, in the space between the ion mirrors while completing plural reflections between the ion mirrors;
at the end of the first time period, cause at least some of the ions trapped by the one or more trapping deflector(s) and/or lens(es) to travel from the one or more trapping deflector(s) and/or lens(es) to the detector for detection; and
during the first time period: cause one or more second packet(s) of ions to be injected from the ion injector into the space between the ion mirrors, such that the ions follow an ion path having one or more oscillation(s) between the ion mirrors in the direction X whilst drifting in the drift direction Y from the ion injector to the detector.

20. An analytical instrument comprising:
an ion source; and
the multi-reflection time-of-flight mass analyser of claim 19.
